(19) United States
(12) Patent Application Publication
(10) Pub. No.: US 2025/0306646 A1
(43) Pub. Date: Oct. 2, 2025

(54) ELECTRONIC APPARATUS AND CONNECTIVE STRUCTURE

(71) Applicant: Lenovo (Beijing) Limited, Beijing (CN)

(72) Inventor: Hujie WANG, Beijing (CN)

(21) Appl. No.: 19/074,373

(22) Filed: Mar. 8, 2025

(30) Foreign Application Priority Data
Mar. 29, 2024 (CN) 202410383144.3

(51) Int. Cl. G06F 1/16

(52) U.S. Cl. CPC G06F 1/1681; G06F 1/1652

(57) ABSTRACT

Electronic apparatus includes first body, connective structure, second body, and deformable screen. The connective structure includes a plate group including four or more plates. The second body is connected to the first body through the connective structure. The deformable screen includes a first portion fixed to the first body, a second portion fixed to the second body, and a deformable portion between the first portion and the second portion. When the first body and the second body are in a first apparatus posture, the plate group of the connective structure forms a flat surface. When the first body and the second body are in a second apparatus posture, the plate group of the connective structure forms an accommodation space. The deformable portion changes between the first state and the second state as the electronic apparatus changes between the first apparatus posture and the second apparatus posture.

### CROSS-REFERENCES TO RELATED APPLICATIONS

The present disclosure claims priority of Chinese Patent Application No. 202410383144.3, filed on Mar. 29, 2024, the entire content of which is hereby incorporated by reference.

### FIELD OF THE DISCLOSURE

The present disclosure generally relates to the field of communication equipment technology and, more particularly, relates to an electronic apparatus and a connective structure.

### BACKGROUND

With the development of technology, deformable electronic apparatus such as foldable mobile phones with flexible screens have come into being. A deformable electronic apparatus may switch between an open posture and a closed posture through a connecting rotation shaft.

Nowadays, when a deformable electronic apparatus is in a closed posture, the deformable portion of the flexible screen may form a waterdrop-shaped structure. The waterdrop-shaped structure may be suspended in the air, and the flexible screen may not be in an ideal protection state.

### SUMMARY

One aspect of the present disclosure includes an electronic apparatus. The electronic apparatus includes a first body and a connective structure. The connective structure includes a plate group, and the plate group includes four or more plates. The electronic apparatus also includes a second body. The second body is connected to the first body through the connective structure. The electronic apparatus also includes a deformable screen. The deformable screen includes a first portion fixed to the first body, a second portion fixed to the second body, and a deformable portion disposed between the first portion and the second portion. When the first body and the second body are in a first apparatus posture through the connective structure, the plate group of the connective structure forms a flat surface for supporting the deformable portion in a first state. When the first body and the second body are in a second apparatus posture through the connective structure, the plate group of the connective structure forms an accommodation space for accommodating and protecting the deformable portion in a second state. The accommodation space includes a polygonal space formed by the four or more plates. The deformable portion changes between the first state and the second state as the electronic apparatus changes between the first apparatus posture and the second apparatus posture.

Another aspect of the present disclosure includes a connective structure. The connective structure includes a plate group. The plate group includes four or more plates. The flat panel group is capable of switching between a first posture and a second posture. When the flat panel group is in the first posture, the flat panel group forms a flat surface capable of supporting a screen in a first state. When the flat panel group is in the second posture, the flat panel group forms an accommodation space for accommodating and protecting the screen in a second state, and the accommodation space includes a polygonal space formed by the four or more flat panels. The screen switches between the first state and the second state as the flat panel group switches between the first posture and the second posture.

Other aspects of the present disclosure may be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a schematic diagram of a first structure of a flat panel group consistent with the disclosed embodiments of the present disclosure;

FIG. 2 illustrates a schematic diagram of a second structure of a flat panel group consistent with the disclosed embodiments of the present disclosure;

FIG. 3 illustrates a schematic diagram of a third structure of a flat panel group consistent with the disclosed embodiments of the present disclosure;

FIG. 4 illustrates a schematic diagram of a first connection structure between a first plate and a second plate, consistent with the disclosed embodiments of the present disclosure;

FIG. 5 illustrates a schematic diagram of a second connection structure between a first plate and a second plate, consistent with the disclosed embodiments of the present disclosure;

FIG. 6 illustrates a schematic structural diagram of a first apparatus posture of an electronic apparatus, consistent with the disclosed embodiments of the present disclosure;

FIG. 7 illustrates a schematic diagram of a first structure between a first apparatus posture and a second apparatus posture of an electronic apparatus, consistent with the disclosed embodiments of the present disclosure;

FIG. 8 illustrates a schematic diagram of a second structure between a first apparatus posture and a second apparatus posture of an electronic apparatus, consistent with the disclosed embodiments of the present disclosure;

FIG. 9 illustrates a schematic diagram of a third structure between a first apparatus posture and a second apparatus posture of an electronic apparatus, consistent with the disclosed embodiments of the present disclosure;

FIG. 10 illustrates a schematic structural diagram of a second apparatus posture of an electronic apparatus, consistent with the disclosed embodiments of the present disclosure;

FIG. 11 illustrates a schematic structural diagram of a first posture of a connective structure, consistent with the disclosed embodiments of the present disclosure;

FIG. 12 illustrates a partial enlarged schematic diagram of part A in FIG. 11, consistent with the disclosed embodiments of the present disclosure;

FIG. 13 illustrates a schematic structural diagram of a second posture of a connective structure, consistent with the disclosed embodiments of the present disclosure;

FIG. 14 illustrates a schematic structural diagram of a combined structure of a torsion structure, a connection component group, a transmission component group, and a movement component group, consistent with the disclosed embodiments of the present disclosure;

FIG. 15 illustrates a schematic structural diagram of another connective structure in a first posture consistent with the disclosed embodiments of the present disclosure; and

FIG. 16 illustrates a schematic structural diagram of another connective structure in a second posture consistent with the disclosed embodiments of the present disclosure.

### DETAILED DESCRIPTION

To make the objectives, technical solutions and advantages of the present disclosure more clear and explicit, the present disclosure is described in further detail with accompanying drawings and embodiments. It should be understood that the specific exemplary embodiments described herein are only for explaining the present disclosure and are not intended to limit the present disclosure.

It should be noted that in the present disclosure, relational terms such as “first” and “second” are only configured to distinguish one entity or operation from another entity or operation, and do not necessarily require or imply that such actual relationship or sequence exists between these entities or operations. Terms “comprise”, “include” or any other variations thereof are intended to cover a non-exclusive inclusion. A process, method, article, or apparatus that includes a series of elements includes not only the series of elements, but also other elements not expressly listed, or elements inherent to such a process, method, article, or apparatus. Without further limitation, an element defined by a statement like “comprises a . . . ” does not exclude the presence of additional identical elements in a process, method, article, or apparatus that includes the foregoing element.

It should be noted that relative arrangements of components and operations, numerical expressions and numerical values set forth in exemplary embodiments are for illustration purposes only and are not intended to limit the present disclosure unless otherwise specified. Techniques, methods and apparatus known to the skilled in the relevant art may not be discussed in detail, but these techniques, methods and apparatus should be considered as a part of the specification, where appropriate.

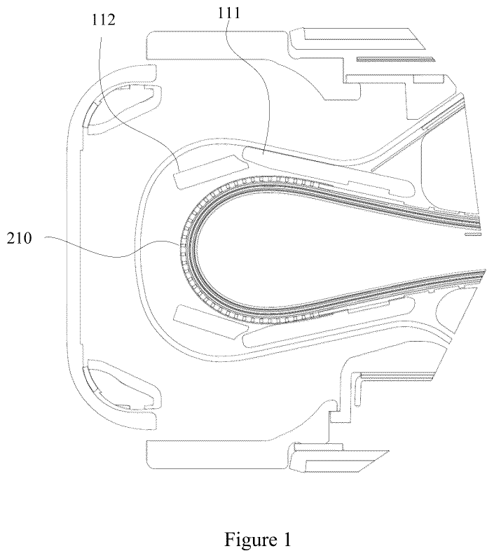

The present disclosure provides an electronic apparatus. FIG. 1 illustrates a schematic diagram of a first structure of a flat panel group consistent with the disclosed embodiments of the present disclosure. As shown in FIG. 1, the electronic apparatus provided by the present disclosure includes a first body, a connective structure, a second body, and a deformable screen. The connective structure includes a plate group, and the plate group includes four or more plates. The second body is connected to the first body through the connective structure. The deformable screen includes a first portion fixed to the first body, a second portion fixed to the second body, and a deformable portion 210 located between the first portion and the second portion.

Among the four or more plates of the plate group, two plates may be connected to each other, or the four or more plates may be relatively independent. The deformable screen may be entirely deformable (such as a flexible screen). When the first portion of the screen is fixed to the first body, the first body may restrict the bending of the first portion of the screen. When the second portion of the screen is fixed to the second body, the second body may restrict the bending of the second portion of the screen. The deformable portion 210 of the screen is located between the first portion and the second portion, such that the deformable portion 210 of the screen may change with different postures of the first body and the second body.

The deformable screen may also be a partially deformable screen. That is, the first portion of the screen and/or the second portion of the screen may not be deformed. Only the deformable portion 210 of the screen located between the first portion and the second portion may change with different postures of the first body and the second body.

When the first body and the second body are in the first apparatus posture through the connective structure, the plate group of the connective structure may form a flat surface for supporting the deformable portion 210 in the first state. When the first body and the second body are in the second apparatus posture through the connective structure, the plate group of the connective structure may form an accommodation space for accommodating and protecting the deformable portion 210 in the second state. The accommodation space may include a polygonal space formed by four or more plates.

The deformable portion 210 may change between a first state and a second state as the electronic apparatus changes between the first apparatus posture and the second apparatus posture. That is, when the electronic apparatus is in the first apparatus posture, the deformable portion 210 is in the first state, and when the electronic apparatus is in the second apparatus posture, the deformable portion 210 is in the second state.

In one embodiment, when the deformable portion 210 of the screen is a planar structure, the deformable portion 210 is in the first state, and when the deformable portion 210 of the screen is a waterdrop-shaped structure, the deformable portion 210 is in the second state.

When the first body and the second body are in the first apparatus posture through the connective structure, the flat surface formed by the plate group of the connective structure may support the deformable portion 210 in the first state. The first portion of the screen is fixed to the first body, and a side of the first body facing the screen supports the first portion of the screen. The second portion of the screen is fixed to the second body, and a side of the second body facing the screen supports the second portion of the screen. That is, when the first body and the second body are in the first apparatus posture through the connective structure, the side of the first body facing the screen, the flat surface formed by the plate group of the connective structure, and the side of the second body facing the screen supports the screen.

Preferably, when the first body and the second body are in the first apparatus posture through the connective structure, the side of the first body facing the screen, the flat surface formed by the plate group of the connective structure, and the side of the second body facing the screen are in a same plane. In this case, the first portion, the deformable portion 210 and the second portion of the screen may be supported into a planar structure.

The first portion, the deformable portion 210 and the second portion of the screen may also be supported into other structures, such as a stepped surface structure. To meet specific support requirements of the first portion, the deformable portion 210 and the second portion of the screen, when the first body and the second body are in the first apparatus posture through the connective structure, the first body facing the screen, the flat surface formed by the plate group of the connective structure, and the second body facing the screen, may be adjusted to specific positions.

When the first body and the second body are in the second apparatus posture through the connective structure, since the first portion of the screen is fixed to the first body, and the second portion of the screen is fixed to the second body, the first portion of the screen and the second portion of the screen may move along with the first body and the second body. In addition, the plate group of the connective structure may form an accommodation space, such that the deformable portion 210 of the screen may be in the second state and may be completely or partially located in the accommodation space.

The accommodation space may protect the deformable portion 210 in the second state. The accommodation space includes the polygonal space formed by the four or more plates. The plate group (including the four or more plates) forming the accommodation space may be in contact with the deformable portion 210 in the second state, thereby playing a protection role for the deformable portion 210 in the second state.

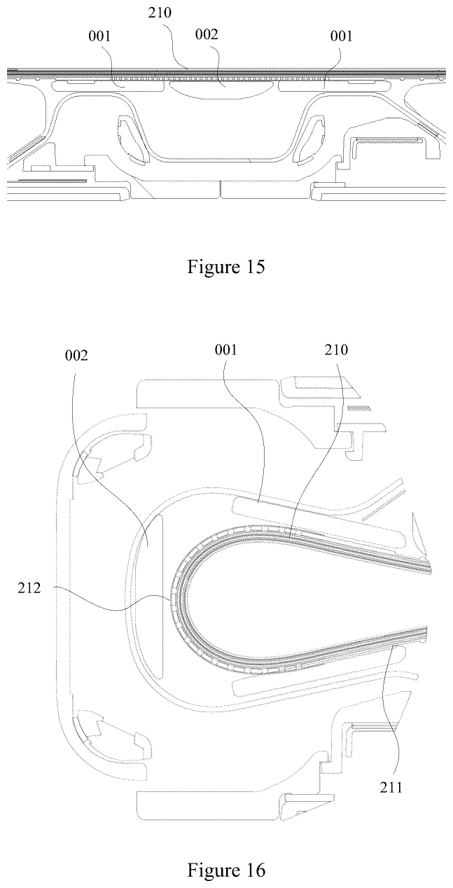

FIG. 15 illustrates a schematic structural diagram of another connective structure in a first posture. FIG. 16 illustrates a schematic structural diagram of another connective structure in a second posture. As shown in FIGS. 15 and 16, in a comparative scheme of the connective structure having only two plates 001, in the first apparatus posture, the flat surface formed by the two plates 001 and the bottom plate 002 supports the deformable portion 210 in the first state (see FIG. 15).

When the electronic apparatus is in the second apparatus posture, the two plates 001 may apply pressure to the deformable portion 210, to make the deformable portion 210 be in the second state, and a space for accommodating the deformable portion 210 in the second state may also be formed (see FIG. 16). When the electronic apparatus is in the second apparatus posture, the first portion and the second portion of the screen may be relatively close and located at the first side 211 of the deformable portion 210. The two plates 001 may need to apply deformation force to the first side 211 of the deformable portion 210. In this case, the second side 212 of the deformable portion 210 may not be in contact with the plate 001, and the second side 212 of the deformable portion 210 may be separated from the bottom plate 002, where the first side 211 and the second side 212 of the deformable portion 210 are opposite to each other.

By taking the comparative scheme shown in FIGS. 15 and 16 as an example, the performance of a conventional electronic apparatus subjected to an impact (such as falling or collision, etc.) is described below.

As shown in FIG. 16, taking the collision of the electronic apparatus with an object (the ground or a table, etc.) located below as an example, the bottom surface of the electronic apparatus collides with the object below. The connective structure and other components of the electronic apparatus (such as the first body, the second body, etc.) may stop moving downward under the action of the impact force. In addition, the first side 211 of the deformable portion 210 may stop moving downward under the restriction of the plate 001. Since the screen is flexible and the second side 212 of the deformable portion 210 is suspended, the second side 212 of the deformable portion 210 may continue to move downward under the action of inertia. After moving downward to a certain position, the second side 212 of the deformable portion 210 may move upward under the action of the elasticity of the deformable portion 210. As such, the second side 212 of the deformable portion 210 may shake in up and down directions, causing the deformable portion 210 to deform. When the deformation amount of the deformable portion 210 is large, the screen may be deformed and damaged. Additionally, when the second side 212 of the deformable portion 210 shakes, the deformable portion 210 may be squeezed with other components of the electronic apparatus (such as the bottom plate 002 or other sharp components), thereby causing squeeze damage to the screen.

When the electronic apparatus provided by the present disclosure is subjected to an impact (such as falling or colliding), the performance of the electronic apparatus is described below.

As shown in FIG. 1, taking the collision between the electronic apparatus and an object (the ground or a tabletop, etc.) located below as an example, the bottom surface of the electronic apparatus collides with the object below. The connective structure and other components of the electronic apparatus (such as the first body, the second body, etc.) may stop moving downward under the action of the impact force. In this case, the first side of the deformable portion 210 is subjected to a deforming force by the two plates in the plate group. The two plates may be two of the four or more plates forming the polygonal space, or may be plates other than the plates forming the polygonal space in the plate group. As such, the first side of the deformable portion 210 may stop moving downward under the restriction of the two plates. The accommodation space may provide protection for the deformable portion 210 in the second state, and the four and more plates in the plate group may be in contact with the deformable portion 210. Since the accommodation space includes the polygonal space formed by the four and more plates, other positions of the deformable portion 210 (including the second side of the deformable portion 210) except the first side may be in contact with the plates forming the polygonal space.

When the second side of the deformable portion 210 tends to move downward under the action of inertia, the contact positions between the deformable portion 210 and the plates may generate pressure. Since the positions of the plates may not change, the pressure may serve as a support force provided by the plates to the deformable portion 210 through the contact positions. As such, the downward movement of the second side of the deformable portion 210 may be slowed down or limited, the shaking of the second side of the deformable portion 210 in up and down directions may be weakened or avoided, and the deformation amount of the deformable portion 210 may thus be reduced. Accordingly, plastic deformation of the screen due to excessive deformation may be prevented, and squeezing damage to the screen caused by squeezing the screen against other components may also be prevented. As a result, the protection effect for the screen may be improved.

That is, when the electronic apparatus is subjected to an impact (such as falling or colliding, etc.), the contact portion between the deformable portion 210 in the second state and the flat panel group may support the deformable portion 210. As such, the protection effect to the deformable portion 210 in the second state may be improved, and the service life of the screen may be improved. In other words, through the contact between the deformable portion 210 and the flat panel group, the flat panel group may support the deformable portion 210 when the electronic apparatus is impacted, and the movement of the deformable portion 210 in the accommodation space may be limited. Accordingly, the degree of shaking of the deformable portion 210 due to factors such as inertia may be reduced, and the damage to the screen caused by the shaking of the deformable portion 210 may be prevented. In addition, since the accommodation space includes the polygonal space formed by the four or more plates, the four or more plates may each contact the deformable portion 210 in the second state. When the electronic apparatus is impacted, the accommodation space may provide support for the deformable portion 210.

When the electronic apparatus is not impacted, the four or more plates forming the polygonal space may only contact the deformable portion 210 in the second state but do not provide supporting force. When the electronic apparatus is impacted and the deformable portion 210 has a tendency to move relative to the polygonal space due to inertia, the contact position may generate supporting force.

In some embodiments, when the electronic apparatus is not impacted, the four or more plates forming the polygonal space may be in contact with the deformable portion 210 in the second state and provide certain squeezing force. The squeezing force may not cause damage to the deformable portion 210 and may limit the movement of the deformable portion 210 in the polygonal space.

In one embodiment, when the electronic apparatus is a foldable device, the first body and the second body being in the first apparatus posture refers to that the first body and the second body are folded relative to each other through the connective structure to form a closed posture. The first body and the second body being in the second apparatus posture refers to that the first body and the second body are unfolded relative to each other through the connective structure to form an unfolded posture, such that the first body and the second body may form a flat structure.

Further, each of the four or more plates in the plate group may be in contact with the deformable portion in the second state. When the plates each contact the deformable portion in the second state, and the first body and the second body are in the second apparatus posture, each plate may provide support for the deformable portion in the second state. Accordingly, the protection effect to the deformable portion in the second state when the electronic apparatus is impacted may be improved.

In some other embodiments, a part of the four or more plates is in contact with the deformable portion in the second state, and other part of the four or more plates may have a certain spacing from the deformable portion in the second state.

As shown in FIG. 1, in a first embodiment, the plate group includes four plates, namely, two first plates 111 and two second plates 112. When the first body or the second body of the electronic apparatus is in contact with a support surface (such as a desktop on which the electronic apparatus is placed), the electronic apparatus is placed in the direction shown in FIG. 1. The center line of the deformable portion 210 in the second state is arranged horizontally. The two first plates 111 are symmetrically arranged on two sides of the center line of the deformable portion 210, and the two second plates 112 are symmetrically arranged on two sides of the center line of the deformable portion 210. The two first plates 111 and the two second plates 112 may each be in contact with the deformable portion 210 in the second state. Since the two first plates 111 may apply force to the deformable portion 210 that causes the deformable portion 210 to be in the second state, the two first plates 111 may be in contact with the deformable portion 210. The two second plates 112 may be in contact with the deformable portion 210 in the second state. Accordingly, the support stability for the deformable portion 210 may be improved, and the protection effect for the deformable portion 210 in the second state may thus be improved.

In one embodiment, one or more of the four plates is not in contact with the deformable portion 210 in the second state. Taking the structure shown in FIG. 1 as an example, the two first plates 111 are in contact with the deformable portion 210. Under the action of gravity, the deformable portion 210 in the second state may be in contact with the second plate 112 located below the center line of the deformable portion 210. The deformable portion 210 in the second state may have a certain spacing from the second plate 112 located above the center line of the deformable portion 210.

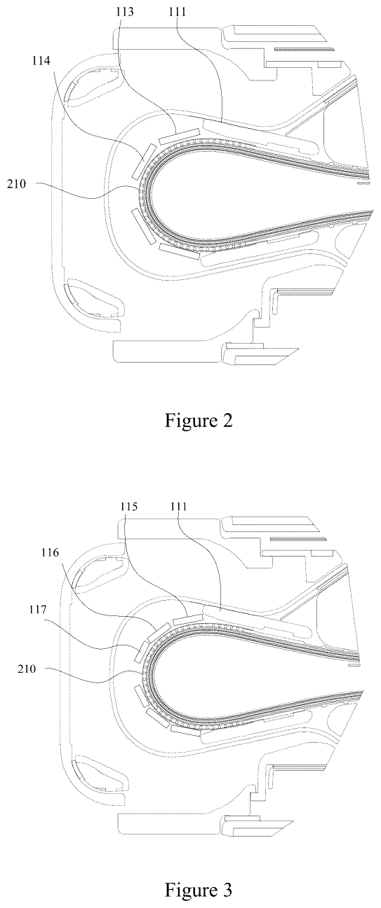

FIG. 2 illustrates a schematic diagram of a second structure of a flat panel group consistent with the disclosed embodiments of the present disclosure. As shown in FIG. 2, in a second embodiment, the plate group includes six plates, namely two first plates 111, two third plates 113, and two fourth plates 114. When the first body or the second body of the electronic apparatus are in contact with a support surface (such as a desktop on which the electronic apparatus is placed), the electronic apparatus is placed in a direction shown in FIG. 2. In the second state, the center line of the deformable portion 210 is arranged horizontally. The two first plates 111 are symmetrically arranged on two sides of the center line of the deformable portion 210. The two third plates 113 are symmetrically arranged on two sides of the center line of the deformable portion 210. The two fourth plates 114 are symmetrically arranged on two sides of the center line of the deformable portion 210. The two first plates 111, the two third plates 113, and the two fourth plates 114 may each be in contact with the deformable portion 210 in the second state. Since the two first plates 111 may apply force to the deformable portion 210 making the deformable portion 210 be in the second state, the two first plates 111 may be in contact with the deformable portion 210. The two third plates 113 and the two fourth plates 114 may each be in contact with the deformable portion 210 in the second state. As such, the support stability for the deformable portion 210 may be improved, and the protection effect for the deformable portion 210 in the second state may thus be improved.

It may be understood that the third plate 113 and the first plate 111 located on a same side of the center line of the deformable portion 210 in the second state (above or below the center line) may be rotatably connected, and the fourth plate 114 and the third plate 113 located on a same side of the center line of the deformable portion 210 in the second state (above or below the center line) may be rotatably connected.

In one embodiment, one or more of the six plates may not be in contact with the deformable portion 210 in the second state. Taking the structure shown in FIG. 2 as an example, the two first plates 111 are in contact with the deformable portion 210. Under the action of gravity, the deformable portion 210 in the second state may be in contact with the third plate 113 and the fourth plate 114 located below the center line of the deformable portion 210. The deformable portion 210 in the second state may have a certain spacing from the third plate 113 and/or the fourth plate 114 located above the center line of the deformable portion 210.

In one embodiment, the six plates may include a plate that is in contact with the deformable portion 210 in the second state and a plate that is not in contact with the deformable portion 210 in the second state. Taking the structure shown in FIG. 2 as an example, the plate group includes two first plates 111, two third plates 113 and two fourth plates 114. The two first plates 111 and the two fourth plates 114 may be in contact with the deformable portion 210, and the two third plates 113 may not be in contact with the deformable portion 210. When the electronic apparatus is impacted, the two fourth plates 114 may be always in contact with the deformable portion 210 in the second state. The deformable portion 210 may be slightly deformed or may have a certain displacement in the accommodation space when subjected to the impact force, and thus the two third plates 113 may also be in contact with the deformable portion 210. As such, the two first plates 111, the two third plates 113 and the two fourth plates 114 may each support the deformable portion 210, and the accommodation space may provide supporting effects at a plurality of positions on the deformable portion 210.

FIG. 3 illustrates a schematic diagram of a third structure of a flat panel group consistent with the disclosed embodiments of the present disclosure. As shown in FIG. 3, in a third embodiment, the plate group includes eight plates, namely, two first plates 111, two fifth plates 115, two sixth plates 116 and two seventh plates 117. When the first body or the second body of the electronic apparatus is in contact with a support surface (such as a desktop on which the electronic apparatus is placed), the electronic apparatus may be placed in the direction shown in FIG. 3. The center line of the deformable portion 210 in the second state may be arranged horizontally. The two first plates 111, the two fifth plates 115, the two sixth plates 116 and the two seventh plates 117 may be symmetrically arranged on two sides of the center line of the deformable portion 210. Since the two first plates 111 may apply force to the deformable portion 210 making the deformable portion 210 be in the second state, the two first plates 111 may be in contact with the deformable portion 210. The two fifth plates 115, the two sixth plates 116 and the two seventh plates 117 may each be in contact with the deformable portion 210 in the second state. As such, the supporting stability of the deformable portion 210 may be improved, and the protection effect of the deformable portion 210 in the second state may thus be improved. In one embodiment, one or more of the two fifth plates 115, the two sixth plates 116, and the two seventh plates 117 may be in contact with the deformable portion 210 in the second state.

It may be understood that, on a same side of the center line of the deformable portion 210 in the second state (above or below the center line), the fifth plate 115 may be rotatably connected to the first plate 111, the sixth plate 116 may be rotatably connected to the fifth plate 115, and the seventh plate 117 may be rotatably connected to the sixth plate 116.

In one embodiment, the flat panel group may include at least a first subgroup and a second subgroup. The first subgroup at least includes two first flat panels 111. The first plate 111 may be a plate that applies force to the deformable portion 210 such that the deformable portion 210 is in the second state. The second subgroup at least includes two second plates 112. The first plate may be rotatably connected to the second plate 112. During the process of the first body and the second body switching from the first apparatus posture to the second apparatus posture, the first plate 111 of the first subgroup may apply a force to the deformable portion 210, such that the deformable portion 210 may be changed from the first state to the second state. The first plate 111 and the second plate 112 may rotate relative to each other, such that the second plate 112 and the first plate 111 may form a polygonal space (accommodation space) to accommodate and protect the deformable portion 210 in the second state.

Preferably, the plate group includes four plates, namely two first plates 111 and two second plates 112. The two first plates 111 and the two second plates 112 are symmetrically arranged. The first plate 111 and the second plate 112 located on a same side of the center line of the deformable portion 210 are rotatably connected.

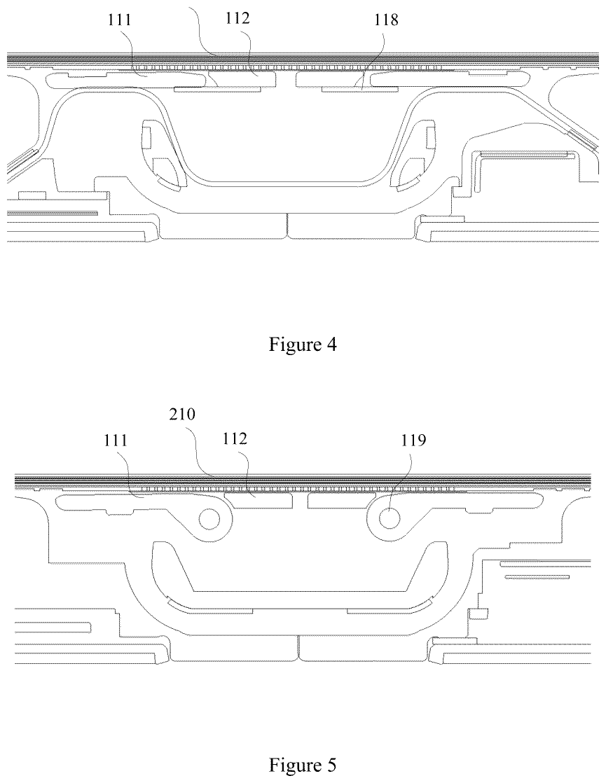

FIG. 4 illustrates a schematic diagram of a first connection structure between a first plate and a second plate, consistent with the disclosed embodiments of the present disclosure. As shown in FIG. 4, in one embodiment, the flat panel group also includes an elastic connection piece 118. The elastic connection piece 118 may be located on a side of the first plate 111 and the second plate 112 facing away from the deformable portion 210. The first plate 111 and the second plate 112 located on a same side may be connected through the elastic connection piece 118. When the electronic apparatus is in the first apparatus posture, under the elastic restoring force of the elastic connection piece 118, the first plate 111 and the second plate 112 may exhibit a 180° angle, and form a flat surface for supporting the deformable portion 210in the first state. When the electronic apparatus is in the second apparatus posture, the elastic force of the elastic connection piece 118 may be overcome, such that the first plate 111 and the second plate 112 may rotate relative to each other, forming a certain angle. Accordingly, the two first plates 111 and the two second plates 112 may form a polygonal space (accommodation space) for accommodating and protecting the deformable portion 210 in the second state.

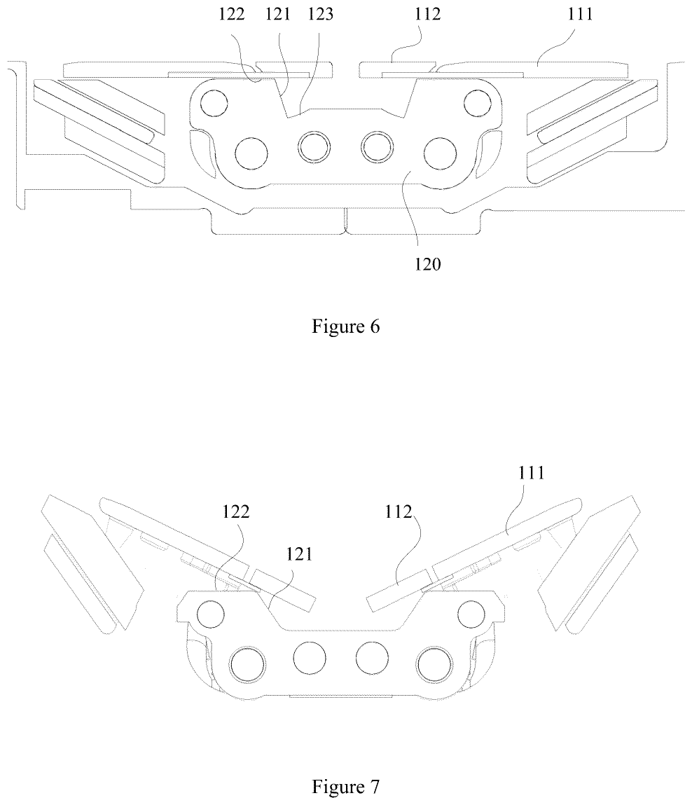

The elastic connection piece 118 may be realized by a soft rubber film injection mechanism. That is, the elastic connection piece 118 may be disposed at the connection place between the first plate 111 and the second plate 112. FIG. 6 illustrates a schematic structural diagram of a first apparatus posture of an electronic apparatus, consistent with the disclosed embodiments of the present disclosure. As shown in FIG. 6, the elastic connection piece 118 may be embedded in the first plate 111 and the second plate 112. Accordingly, the structural compactness of the first plate 111 and the second plate 112 may be improved, and the space occupied may be reduced.

FIG. 5 illustrates a schematic diagram of a second connection structure between a first plate and a second plate, consistent with the disclosed embodiments of the present disclosure. As shown in FIG. 5, in one embodiment, the plate group also includes a connection shaft 119, and the first plate 111 and the second plate 112 located on a same side are rotatably connected through the connection shaft 119. That is, the first plate 111 and the second plate 112 are rotatably connected to each other through a hinge connection. A structure such as a torsion spring may be used, such that the first plate 111 and the second plate 112 may exhibit a 180° angle and form a flat surface when the electronic apparatus is in the first apparatus posture. The torsion spring may be sleeved on the connection shaft 119, with two ends of the torsion spring contacted to the first plate 111 and the second plate 112 respectively. As such, the first plate 111 and the second plate 112 may maintain an angle of 180° and form a flat surface through the torsion spring, for supporting the deformable portion 210 in the first state. When the electronic apparatus is in the second apparatus posture, the first plate 111 and the second plate 112 may rotate relative to each other at a certain angle, such that the two first plates 111 and the two second plates 112 may form a polygonal space (accommodation space) for accommodating and protecting the deformable portion 210 in the second state.

To improve the supporting effect of the first plate 111 and the second plate 112 for the deformable portion 210 in the first state when the electronic apparatus is in the first apparatus posture, the spacing between the first plate 111 and the second plate 112 may be small. In order not to affect the relative rotation between the first plate 111 and the second plate 112, one end of the first plate 111 facing the second plate 112 and/or one end of the second plate 112 facing the first plate 111 may have a rotation avoidance structure. When the electronic apparatus switches from the first apparatus posture to the second apparatus posture, the rotation avoidance structure of the first plate 111 may avoid the second plate 112, and the rotation avoidance structure of the second plate 112 may avoid the first plate 111.

To improve the structural stability of the deformable portion 210 in the first state, when the first body and the second body are in the first apparatus posture, each of the four or more flat panels in the flat panel group may be in contact with the deformable portion 210 in the first state. That is, when the first body and the second body are in the first apparatus posture, each of the four or more plates in the plate group may form a flat surface for supporting the deformable portion 210 in the first state.

In some other embodiments, a part of the plates in the plate group may be made to form a flat surface for supporting the deformable portion 210 in the first state. A certain spacing may exist between the deformable portion 210 in the first state and the other part of the plates.

For design convenience, when the plate group forms a polygonal space, the rotational connection point between the first plate and the second plate corresponds to the tangent point of the arc surface of the deformable portion 210 in the second state. As shown in FIG. 1, the tangent point of the arc surface of the deformable portion 210 in the second state is the tangent point between the deformable portion 210 in the second state and the horizontal line. By aligning the rotational connection between the first plate and the second plate with the tangent point between the deformable portion 210 in the second state and the horizontal line, the arc surface of the deformable portion 210 may be located within the angle formed by the first plate and the second plate in the second apparatus posture. As such, the first plate and the second plate may be prevented from squeezing the arc surface of the deformable portion 210. Accordingly, the protection effect of the polygonal space formed by the plate group for the deformable portion 210 in the second state may be improved.

When the plate group forms a polygonal space, the first subgroup may provide a deformation force to make the deformable portion 210 be in the second state, and the second subgroup may provide protection for the deformable portion in the second state. That is, the two first plates 111 of the first subgroup may apply a deformation force to the deformable portion 210, such that the deformable portion 210 may be in the second state; the two second plates 112 of the second subgroup may be in contact with the deformable portion 210 in the second state. When the electronic apparatus is impacted, the second plates 112 may support the deformable portion 210 in the second state. As such, the movement of the deformable portion 210 may be restricted, and the deformable portion may thus be protected. The two second plates 112 of the second subgroup may also apply certain force to the deformable portion 210 in the second state, and the force may also limit the movement of the deformable portion 210.

The connective structure also includes a control component 120 for providing an abutment force to change the relative position relationship between the second plate 112 of the second subgroup and the first plate 111 of the first subgroup when the electronic apparatus changes between the first apparatus posture and the second apparatus posture. That is, the control component 120 may be configured to provide the abutment force when the electronic apparatus changes between the first apparatus posture and the second apparatus posture. The second plate 112 may change the position relative to the first plate 111 under the abutment force, such that adjustment may be made from a state where the plates form a flat surface to a state where the plates form an accommodation space.

The control component 120 includes two opposite inclined surfaces 121. In the process of the electronic apparatus switching from the first apparatus posture to the second apparatus posture, the second plate 112 of the second subgroup and the first subgroup, with the first relative position relationship, are moved to a position with an angle consistent with the inclined surface 121. The inclined surface 121 may provide abutment force for the second plate 112 of the second subgroup to change the first relative position relationship with respect to the first plate 111 of the first subgroup, until the second plate of the second subgroup is in a second relative position relationship with respect to the first subgroup.

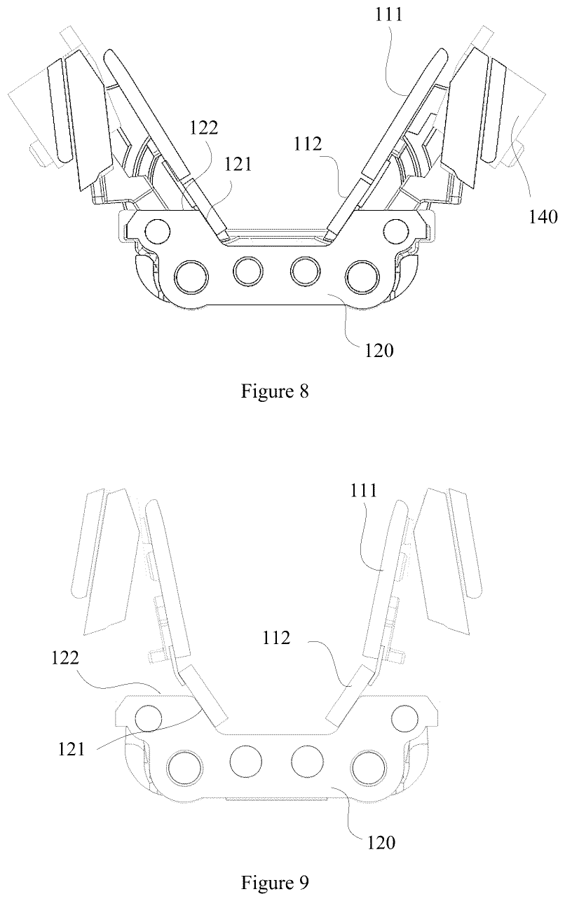

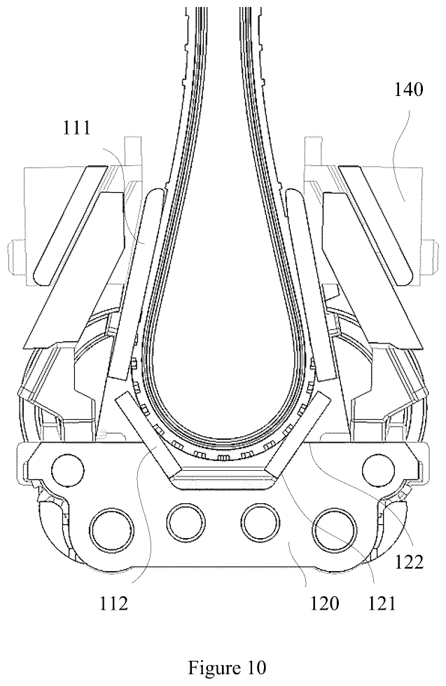

FIG. 7 illustrates a schematic diagram of a first structure between a first apparatus posture and a second apparatus posture of an electronic apparatus, consistent with the disclosed embodiments of the present disclosure. FIG. 8 illustrates a schematic diagram of a second structure between a first apparatus posture and a second apparatus posture of an electronic apparatus, consistent with the disclosed embodiments of the present disclosure. FIG. 9 illustrates a schematic diagram of a third structure between a first apparatus posture and a second apparatus posture of an electronic apparatus, consistent with the disclosed embodiments of the present disclosure. FIG. 10 illustrates a schematic structural diagram of a second apparatus posture of an electronic apparatus, consistent with the disclosed embodiments of the present disclosure. In one embodiment, the process of the electronic apparatus switching from the first apparatus posture to the second apparatus posture is sequentially shown in FIG. 6 to FIG. 8 to FIG. 10.

As shown in FIG. 6, when the electronic apparatus is in the first apparatus posture, the second plate 112 of the second subgroup is in the first relative position relationship with the first subgroup. The first relative position relationship is a state in which the second plate 112 and the first plate 111 rotatably connected thereto exhibit a 180° angle, forming a flat surface. That is, when the angle between the second plate 112 and the first plate 111 is 180°, the second plate 112 of the second subgroup is in the first relative position relationship relative to the first subgroup.

As shown in FIG. 7, during the state switching process from FIG. 6 to FIG. 8, the second plate 112 of the second subgroup is in a first relative position relationship with the first subgroup, and the first plate 111 of the first subgroup drives the second plate 112 connected thereto to move. During this process, the second plate 112 is located at a fixed position relative to the first plate 111, and the angle between the second plate 112 and the first plate 111 is maintained at 180°. In other words, the second plate 112 does not rotate relative to the first plate 111.

As shown in FIG. 8, during the process of the electronic apparatus switching from the first apparatus posture to the second apparatus posture, there is a critical state that the inclined surface 121 provides abutment force for the second plate 112 of the second subgroup to change the first relative position relationship with respect to the first plate 111 of the first subgroup. That is, the inclined surface 121 is in contact with the second plate 112 of the second subgroup but does not provide a contact force. At this time, the second plate 112 of the second subgroup is still in the first relative position relationship with the first subgroup. That is, the second plate 112 and the first plate 111 rotatably connected thereto exhibit a 180° angle, forming a flat surface, and the angle of the second plate 112 (and the first plate 111) is consistent with the angle of the inclined surface 121.

As shown in FIG. 9, during the state switching process from FIG. 8 to FIG. 10, the inclined surface 121 provides abutment force for changing the first relative position relationship of the second plate 112 of the second subgroup relative to the first plate 111 of the first subgroup. The second plate 112 is limited relative to the control component under the abutment force of the inclined surface 121, while the first plate 111 may continue to move. Accordingly, the first plate 111 may rotate relative to the second plate 112 rotatably connected thereto, such that the angle between the second plate 112 and the first plate 111 may be reduced from 180°.

The angle between the second plate 112 and the first plate 111 may be further reduced until the state shown in FIG. 10 is realized. That is, the electronic apparatus is in the second apparatus posture, and the plate group forms an accommodation space. In this case, a predetermined angle may be formed between the second plate 112 and the first plate 111, and the predetermined angle is less than 180°. Accordingly, an angle corresponding to the polygonal space may thus be formed. In this case, the second plate 112 of the second subgroup is in a second relative position relationship with the first subgroup.

As such, FIG. 6, FIG. 7, FIG. 8, FIG. 9 and FIG. 10 sequentially correspond to states in the process of the electronic apparatus switching from the first apparatus posture to the second apparatus posture.

As shown in FIGS. 4, 5 and 6, to improve the supporting effect, the control component 120 also includes a horizontal surface 122. When the electronic apparatus is in the first apparatus posture, the second plate 112 and the first plate 111 are in contact with the horizontal plane 122. The horizontal surface 122 provides supporting force for the second plate 112 and the first plate 111, such that the second plate 112 and the first plate 111 in a flat surface state may provide supporting force for the deformable portion 210 in the first state.

Preferably, a groove may be formed on a side of the control component 120 facing the screen. The sidewall of the groove is the inclined surface 121, and the region of the control component 120 facing the screen where the groove is not formed is the horizontal surface 122.

As shown in FIG. 6, the bottom surface of the groove has a concave structure 123. In one embodiment, the groove includes two concave structures 123 which are symmetrically arranged on two sides of the bottom surface of the groove. Two sides of the bottom surface of the groove are connected to the two inclined surfaces 121 respectively. When the electronic apparatus switches from the first apparatus posture to the second apparatus posture, opposite ends of the two second plates 112 extend into the groove. The concave structure 123 may avoid the second plate 112 from extending into the end of the groove, thereby preventing the bottom of the groove from hindering the movement of the second plate 112. The concave structure 123 may be a concave arc structure, or a rectangular concave structure, or other structures, provided that the function of avoiding the end of the second plate 112 from extending into the groove is realized.

To improve the supporting effect on the deformable portion 210 in the first state, other components of the connective structure may also have support surfaces. When the electronic apparatus is in the first apparatus posture, the support surfaces of other components are coplanar with the horizontal surface 122 of the control component 120. As such, the supporting area of the second plate 112 and the first plate 111 may be increased, and the supporting effect may thus be improved.

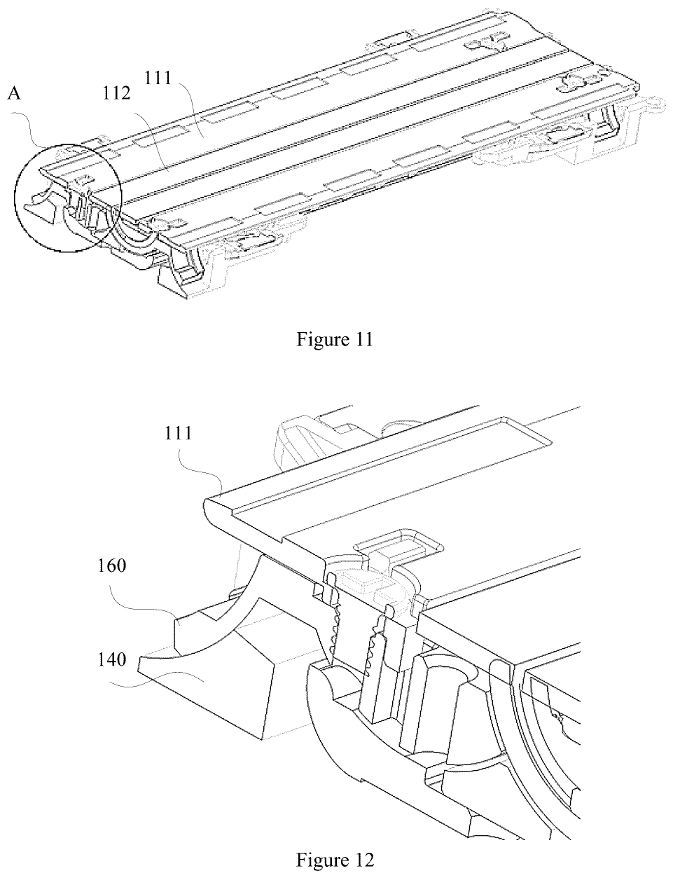

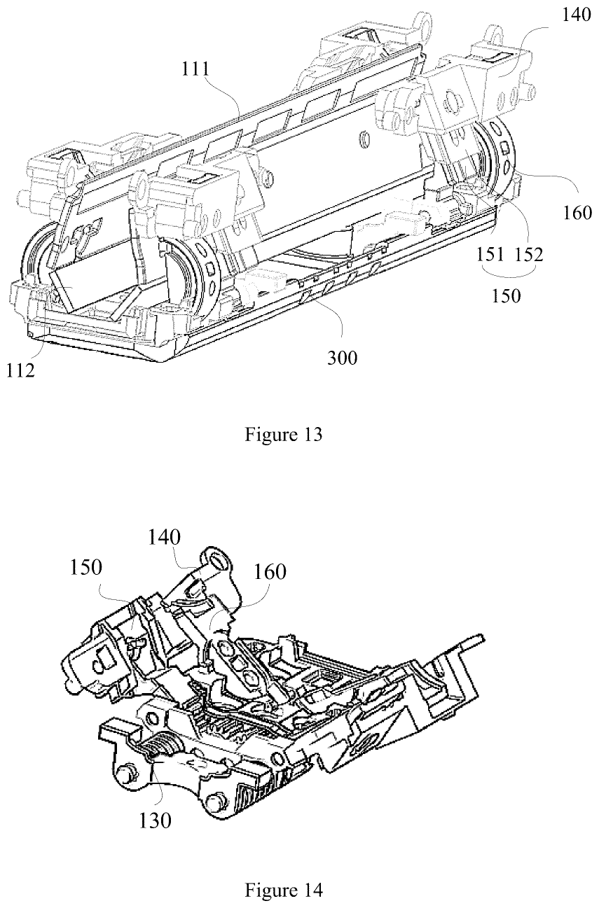

FIG. 11 illustrates a schematic structural diagram of a first posture of a connective structure, consistent with the disclosed embodiments of the present disclosure. FIG. 12 illustrates a partial enlarged schematic diagram of part A in FIG. 11. FIG. 13 illustrates a schematic structural diagram of a second posture of a connective structure, consistent with the disclosed embodiments of the present disclosure. FIG. 14 illustrates a schematic structural diagram of a combined structure of a torsion structure, a connection component group, a transmission component group, and a movement component group, consistent with the disclosed embodiments of the present disclosure. As shown in FIGS. 11-14, the connective structure may also include a torsion structure, a connection component group 140, a transmission component group 150, and a movement component group 160.

The connection component group 140 includes a first connection component fixedly connected to the first body, and a second connection component fixedly connected to the second body. The transmission component group 150 is movably connected with the connection component group 140 and the torsion structure 130. The movement component group 160 is fixedly connected to the first subgroup, and the movement component group 160 is movably connected to the connection component group 140.

As shown in FIGS. 11 and 12, in one embodiment, the connective structure includes two movement component groups 160 and the two movement component groups are symmetrically arranged. One of the movement component groups 160 is movably connected to the first connection component of the connection component group 140, and the other movement component group 160 is movably connected to the second connection component of the connection component group 140. Taking one movement component group 160 as an example, the movement component group 160 includes a first arc surface structure, and the first connection component of the connection component group 140 includes a second arc surface structure. The first arc surface structure and the second arc surface structure may slide relative to each other. When the electronic apparatus switches between the first apparatus posture and the second apparatus posture, the movement component group 160 and the first connection component of the connection component group 140 may slide along an arc matching surface. Since the movement component group 160 is fixedly connected to the first plate 111 of the first subgroup, the movement component group 160 may drive the first plate 111 to move.

In one embodiment, the electronic apparatus includes two sets of combined structures including the torsion structure 130, the connection component group 140, the transmission component group 150 and the movement component group 160. The two sets of combined structures are arranged along the extension direction of the central housing 300 of the electronic apparatus. When the electronic apparatus is in the first apparatus posture, the central housing 300 is located between the first body and the second body. The first plate 111 of the first subgroup and the second plate of the second subgroup each are arranged along the extension direction of the central housing 300. FIG. 14 shows one set of combined structures including the torsion structure 130, the connection component group 140, the transmission component group 150 and the movement component group 160.

As shown in FIGS. 13 and 14, the connective structure includes two transmission component groups 150 that are symmetrically arranged. One of the two transmission component groups 150 is movably connected to the first connection component of the connection component group 140, and the other transmission component group 150 is movably connected to the second connection component of the connection component group 140. Taking one transmission component group 150 as example for explanation, the transmission component group 150 includes a first transmission arm 151 and a second transmission arm 152 that may be slidably connected. The first transmission arm 151 may be slidably matched with the first connection component of the connection component group 140. The first transmission arm 151 and the second transmission arm 152 are slidably matched to each other. The second transmission arm 152 is connected to the torsion structure 130. When the electronic apparatus switches between the first apparatus posture and the second apparatus posture, the torsion structure 130 may provide torsion to the second transmission arm 152. The first connection component of the connection component group 140, the first transmission arm 151 and the second transmission arm 152 may slide relative to each other. Accordingly, while torsion is being applied to the first connection component of the connection component assembly 140, the position change between the connection component assembly 140 and the torsion structure 130 may not be hindered.

The two transmission component groups 150 may be connected through intermediate connection components such as transmission gears. As such, in the process of the electronic apparatus switching between the first apparatus posture and the second apparatus posture, the two transmission component groups 150 may move synchronously.

Preferably, one or more of the torsion structure 130, the connection component group 140, the transmission component group 150 and the movement component group 160 includes a flat support surface on a side facing the screen. When the electronic apparatus is in the first apparatus posture, the flat support surface may provide support force to the second plate 112 and/or the first plate 111. As such, the second plate 112 and the first plate 111 in a flat surface state may provide support force to the deformable portion 210 in the first state. When the electronic apparatus is in the first apparatus posture, the flat support surface may be coplanar with the horizontal surface 122 of the control component 120.

The present disclosure also provides a connective structure. The connective structure includes a plate group, and the plate group includes four or more plates. The flat panel group of the connective structure may be switched between a first posture and a second posture.

When the flat panel group is in the first posture, the flat panel group may form a flat surface capable of supporting the screen in the first state. When the flat panel group is in the second posture, the flat panel group may form an accommodation space for accommodating and protecting the screen in the second state, and the accommodation space may include a polygonal space formed by the four or more flat panels.

The screen may change between the first state and the second state as the flat panel group changes between the first posture and the second posture. That is, when the flat panel group is in the first posture, the screen is in the first state; when the flat panel group is in the second posture, the screen is in the second state. In one embodiment, when the screen is a planar structure, the screen is in the first state, and when the screen is a waterdrop-shaped structure, the screen is in the second state.

The connective structure provided by the present disclosure has the technical advantages of the electronic apparatus provided by the present disclosure. That is, through the contact between the screen and the flat panel group, when the electronic apparatus is impacted, the flat panel group may support the screen, restrict the movement of the screen in the accommodation space, and reduce the shaking of the screen due to factors such as inertia. As such, screen damage caused by screen shaking may be avoided. In addition, since the accommodation space includes a polygonal space formed by four or more flat panels, the four or more flat panels may each be in contact with the screen in the second state. When the electronic apparatus is impacted, the accommodation space may provide support for the screen at a plurality of locations. Accordingly, the screen may be prevented from being squeezed and damaged by contact at a single location.

The screen mentioned above may be a part of a screen (such as the deformable portion 210), that is, a part of the screen accommodated and protected by the accommodation space formed by the flat panel group in the second posture. The screen mentioned above may also be an entire screen, that is, the entire of the screen accommodated and protected by the accommodation space formed by the flat panel group in the second posture.

Preferably, the flat panel group includes at least a first subgroup and a second subgroup. The first subgroup at least includes two first plates 111. The first plate 111 is a plate that may apply force to the screen to make the screen be in the second state. The second subgroup at least includes two second plates 112. The first plate is rotatably connected to the second plate 112. During the process of the first body and the second body switching from the first apparatus posture to the second apparatus posture, the first plate 111 of the first subgroup may apply force to the screen, such that the screen is deformed from the first state to the second state. The first plate 111 and the second plate 112 may rotate relative to each other. As such, the second plate 112 and the first plate 111 may form a polygonal space (accommodation space) to accommodate and protect the screen in the second state.

As disclosed, the technical solutions of the present disclosure have the following advantages.

In the electronic apparatus and the connective structure provided in the present disclosure, through the contact between the screen and the flat panel group, when the electronic apparatus is impacted, the flat panel group may support the screen, restrict the movement of the screen in the accommodation space, and reduce the shaking of the screen due to factors such as inertia. As such, screen damage caused by screen shaking may be avoided. In addition, since the accommodation space includes a polygonal space formed by four or more flat panels, the four or more flat panels may each be in contact with the screen in the second state. When the electronic apparatus is impacted, the accommodation space may provide support for the screen at a plurality of locations. Accordingly, the screen may be prevented from being squeezed and damaged by contact at a single location.

The embodiments disclosed in the present disclosure are exemplary only and not limiting the scope of the present disclosure. Various combinations, alternations, modifications, or equivalents to the technical solutions of the disclosed embodiments may be obvious to those skilled in the art and may be included in the present disclosure. Without departing from the spirit of the present disclosure, the technical solutions of the present disclosure may be implemented by other embodiments, and such other embodiments are intended to be encompassed within the scope of the present disclosure.

What is claimed is:

1. An electronic apparatus, comprising:
a first body;
a connective structure, wherein the connective structure includes a plate group, and the plate group includes four or more plates;
a second body, wherein the second body is connected to the first body through the connective structure; and
a deformable screen, wherein the deformable screen includes a first portion fixed to the first body, a second portion fixed to the second body, and a deformable portion disposed between the first portion and the second portion,
wherein:
when the first body and the second body are in a first apparatus posture through the connective structure, the plate group of the connective structure forms a flat surface for supporting the deformable portion in a first state;
when the first body and the second body are in a second apparatus posture through the connective structure, the plate group of the connective structure forms an accommodation space for accommodating and protecting the deformable portion in a second state, wherein the accommodation space includes a polygonal space formed by the four or more plates; and
the deformable portion changes between the first state and the second state as the electronic apparatus changes between the first apparatus posture and the second apparatus posture.

2. The electronic apparatus according to claim 1, wherein:
the four or more plates in the plate group are each in contact with the deformable portion in the second state.

3. The electronic apparatus according to claim 2, wherein the flat panel group at least includes:
a first subgroup, at least including two first flat panels of the four or more plates; and
a second subgroup, at least including two second plates of the four or more plates,
wherein:
a first plate of the two first flat panels is rotatably connected to a second plate of the two second plates.

4. The electronic apparatus according to claim 3, wherein:
when the plate group forms the polygonal space, a rotational connection point between the first plate and the second plate corresponds to a tangent point of an arc surface of the deformable portion in the second state.

5. The electronic apparatus according to claim 3, wherein:
when the plate group forms the polygonal space, the first subgroup provides deformation force to make the deformable portion be in the second state, and the second subgroup provides protection for the deformable portion in the second state.

6. The electronic apparatus according to claim 3, wherein the connective structure further includes a control component, wherein:
the control component provides abutment force to change a relative position relationship between the second plate of the second subgroup and the first plate of the first subgroup, when the electronic apparatus changes between the first apparatus posture and the second apparatus posture.

7. The electronic apparatus according to claim 6, the control component includes two inclined surfaces that are opposite to each other, wherein:
in a process of the electronic apparatus switching from the first apparatus posture to the second apparatus posture, the second plate of the second subgroup and the first subgroup, in a first relative position relationship, are moved to a position with an angle consistent with an inclined surface of the two inclined surfaces; and
the inclined surface provides abutment force for the second plate of the second subgroup to change the first relative position relationship with respect to the first plate of the first subgroup, until the second plate of the second subgroup is in a second relative position relationship with respect to the first subgroup.

8. The electronic apparatus according to claim 7, wherein the connective structure further includes:
a torsion structure;
a connection component group, including a first connection component fixedly connected to the first body, and a second connection component fixedly connected to the second body;
a transmission component group, movably connected with the connection component group and the torsion structure; and
a movement component group, fixedly connected to the first subgroup, and movably connected to the connection component group.

9. The electronic apparatus according to claim 1, wherein:
when the deformable portion of the deformable screen is a planar structure, the deformable portion is in the first state; and
when the deformable portion of the deformable screen is a waterdrop-shaped structure, the deformable portion is in the second state.

10. The electronic apparatus according to claim 1, wherein:
when the first body and the second body are in the first apparatus posture through the connective structure, a side of the first body facing the deformable screen, the flat surface formed by the plate group of the connective structure, and a side of the second body facing the deformable screen are in a same plane.

11. The electronic apparatus according to claim 1, wherein:
a part of the four or more plates is in contact with the deformable portion in the second state, and another part of the four or more plates has a spacing from the deformable portion in the second state.

12. The electronic apparatus according to claim 1, wherein:
the plate group includes four plates, including two first plates and two second plates; and
the two first plates are symmetrically disposed on two sides of a center line of the deformable portion, and the two second plates are symmetrically disposed on two sides of the center line of the deformable portion.

13. The electronic apparatus according to claim 3, wherein the flat panel group further includes an elastic connection piece, wherein:
the elastic connection piece is located on a side of the first plate and the second plate facing away from the deformable portion; and
the first plate and the second plate located on a same side of a center line of the deformable portion are connected through the elastic connection piece.

14. The electronic apparatus according to claim 3, wherein the plate group further includes a connection shaft, wherein:
the first plate and the second plate on a same side of a center line of the deformable portion are rotatably connected through the connection shaft.

15. The electronic apparatus according to claim 7, wherein:
a groove is formed on a side of the control component facing the deformable screen, wherein a sidewall of the groove is the inclined surface.

16. The electronic apparatus according to claim 8, wherein:
the connective structure includes two movement component groups of the movement component group, and the two movement component groups are symmetrically disposed on two sides of a center line of the deformable portion; and
one movement component group of the two movement component groups is movably connected to the first connection component of the connection component group, and another movement component group of the two movement component groups is movably connected to the second connection component of the connection component group.

17. The electronic apparatus according to claim 8, wherein:
the connective structure includes two transmission component groups of the transmission component group, and the two movement component groups are symmetrically disposed on two sides of a center line of the deformable portion; and
one transmission component group of the two transmission component groups is movably connected to the first connection component of the connection component group, and another transmission component group of the two transmission component groups is movably connected to the second connection component of the connection component group.

18. The electronic apparatus according to claim 17, wherein:
the two transmission component groups are connected through an intermediate connection component.

19. A connective structure, comprising a plate group, wherein:
the plate group includes four or more plates;
the flat panel group is capable of switching between a first posture and a second posture;
when the flat panel group is in the first posture, the flat panel group forms a flat surface capable of supporting a screen in a first state;
when the flat panel group is in the second posture, the flat panel group forms an accommodation space for accommodating and protecting the screen in a second state, and the accommodation space includes a polygonal space formed by the four or more flat panels; and
the screen switches between the first state and the second state as the flat panel group switches between the first posture and the second posture.

20. The connective structure according to claim 9, wherein the flat panel group at least includes:
a first subgroup, at least including two first flat panels of the four or more plates; and
a second subgroup, at least including two second plates of the four or more plates,
wherein:
a first plate of the two first flat panels is rotatably connected to a second plate of the two second plates.
